(19) United States
(12) Patent Application Publication
(10) Pub. No.: US 2016/0311024 A1
(43) Pub. Date: Oct. 27, 2016

(54) Method and Device for Producing a Three-Dimensional Object

(71) Applicant: EOS GmbH Electro Optical Systems, Krailling (DE)

(72) Inventor: Thomas Thiel, Munchen (DE)

(73) Assignee: EOS GmbH Electro Optical Systems, Krailling (DE)

(21) Appl. No.: 15/133,774

(22) Filed: Apr. 20, 2016

(30) Foreign Application Priority Data
Apr. 22, 2015 (DE) 102015207306.8

(51) Int. Cl. B22F 3/105; B29C 67/00; G05B 19/4099; B22F 5/00

(52) U.S. Cl. CPC B22F 3/1055; B22F 5/00; B29C 67/0088; B29C 67/0092; G05B 19/4099; B33Y 10/00

(57) ABSTRACT

A method for producing a three-dimensional object (2) by layer-by-layer application and selective solidification of a build-up material (13) comprises the steps: applying a layer of the build-up material (13) on a construction field by means of a coater (14) moving above the construction field, selectively solidifying the applied layer at points which correspond to a cross section of the object (2) to be produced, and repeating the steps of application and selective solidification until the object (2) is finished. In this case, firstly a support structure (30) is formed on a construction platform (9) and then the object (2) is formed on the support structure (30) by the above steps, wherein the support structure (30) has a weakened region (30b), which is arranged on average closer to the construction platform (9) than to the object (2) and which is more easily severable than the regions (30a) of the support structure adjacent in height.

The present invention relates to a method and a device for producing a three-dimensional object by selective layer-by-layer solidification of build-up material.

Methods and devices of this type are used, for example, in rapid prototyping, rapid tooling, or additive manufacturing. One example of such a method is known under the name “selective laser sintering or laser melting”. In this case, a thin layer of a powdered build-up material is applied repeatedly and the build-up material in each layer is selectively solidified by selective irradiation using a laser beam.

DE 195 38 257 A1 describes a method in which, in addition to the production of an object, the production of a support structure for supporting parts of the object or the entire object is provided. To enable easy detachment of the support structure from the produced object, the support structure is broken down into an inner core region and an outer envelope region and the envelope region is exposed less strongly.

In particular in the case of metallic build-up materials, it is advantageous to produce the object on a construction platform, to which the build-up material adheres during the solidification. Such a method is known from DE 195 11 772 C2. The produced three-dimensional object can be severed from the construction platform after manufacturing, or the construction platform forms an integral component of the object.

If the object is manufactured on a support structure, a balance between sufficient stability to support the object and good severability for the severing from the construction platform is to be found with respect to the thickness of the selected support structure.

The object of the present invention is to provide an alternative, preferably improved method for producing a three-dimensional object having a support structure, as well as a device which is suitable for carrying out the method, wherein in particular the removal of the support structure with the finished object from the construction platform can be implemented rapidly and in a simple manner.

The object is achieved by a method according to claim 1 and a device according to claim 15. Refinements of the invention are specified in the dependent claims. In this case, the device can also be refined by the features of the method, which are set forth below and/or in the dependent claims, and vice versa.

The method according to the invention for producing a three-dimensional object by layer-by-layer application and selective solidification of a build-up material comprises the steps: applying a layer of the build-up material on a construction field by means of a coater moving above the construction field, selectively solidifying the applied layer at points which correspond to a cross section of the object to be produced, and repeating the steps of application and selective solidification until the object is finished. In this case, firstly a support structure is formed on a construction platform and then the object is formed on the support structure by the above steps, wherein the support structure has a weakened region, which is arranged on average closer to the construction platform than to the object and which is more easily severable than the regions of the support structure adjacent in height.

This method enables simple and rapid severing of the support structure from the construction platform after finishing of the object, since the weakened region of the support structure is easily severable. The non-weakened regions of the support structure above and below the weakened region ensure good bonding of the component to the construction platform, and sufficient stability of the support structure. Due to the nearly complete removal of the support structure from the construction platform, the construction platform can be reused for a further construction procedure.

To form the weakened region of the support structure, the build-up material can be solidified less strongly there than in the regions of the support structure which are adjacent in height. If the material is solidified by introducing energy, the weakened region of the support structure can thus be formed in particular in that less energy per unit of area is supplied there to the build-up material than to the regions of the support structure adjacent in height. If the material is solidified by radiation, the weakened region of the support structure can thus be formed in particular in that the build-up material is irradiated more weakly there than in the regions of the support structure adjacent in height. Additionally or alternatively, the weakened region of the support structure can be formed in that the solidified cross-sectional area of the support structure is smaller there than that at the regions of the support structure adjacent in height. Multiple alternative methods are thus provided, using which it is possible to implement the weakened region of the support structure in a simple manner.

The support structure is preferably formed so that it consists of individual supports, between which a distance is located in parallel to the construction platform. This means that at least two separate supports are provided in the support structure, between which a distance is located in parallel to the construction platform. The embodiment of the support structure as individual supports enables uniform support of the object or parts of the object. In addition, individual supports are structurally simpler to implement and require less build-up material than large area support structures.

In this case, transverse connections are preferably arranged in sections between the individual supports, which connect adjacent supports to one another. The stability of the support structure consisting of individual supports is thus increased.

The weakened region of the support structure is preferably formed so that it is arranged at a substantially constant height above the construction platform over the entire construction platform. This makes it easier to sever the support structure from the construction platform after finishing the object, for example, by guiding a saw blade at a constant height above the construction platform through the weakened region.

A lower boundary of the weakened region of the support structure is preferably provided spaced apart from the construction platform, which boundary preferably is located at least 0.1 mm and/or at most 1.0 mm, particularly preferably at least 0.3 mm and/or at most 0.5 mm above the construction platform. An upper boundary of the weakened region of the support structure is preferably provided, which boundary is located at least 0.3 mm and/or at most 5.0 mm, preferably at least 0.5 mm and/or at most 2.5 mm above the construction platform. Because the weakened region does not directly adjoin the construction platform, good bonding of the support structure to the construction platform is achieved. At the same time, the weakened region is formed close to the construction platform, so that after the support structure is severed from the construction platform, only a small part of the support structure remains on the construction platform.

The build-up material is preferably a powdered material, more preferably a metal powder. Since metallic materials are particularly difficult to sever, a particularly good effect may be achieved by the weakened region if metal powders are used as the build-up material.

A computer program according to the invention is loadable into a programmable control unit and comprises program code means to execute all steps of the above-described method when the computer program is executed on the control unit. It is thus possible to execute the method according to the invention in a simple manner by executing the computer program in a control unit.

A control unit according to the invention is provided for a device for producing a three-dimensional object by layer-by-layer application and selective solidification of a build-up material, wherein the device comprises a coater movable above a construction field for applying a layer of the build-up material to the construction field, and a solidification device for selectively solidifying the applied layer at points which correspond to a cross section of the object to be produced. The device according to the invention is designed to repeat the steps of application and selective solidification until the object is finished. The control unit is designed to control the device so that it firstly forms a support structure on a construction platform and then forms the object on the support structure, and forms the support structure so that it has a weakened region, which is arranged on average closer to the construction platform than to the object and which is more easily severable than the regions of the support structure adjacent in height. It is thus possible to execute the method according to the invention by means of the control unit.

A device according to the invention for producing a three-dimensional object by layer-by-layer application and selective solidification of a build-up material comprises: a coater movable above a construction field, for applying a layer of the build-up material to the construction field and a solidification device for selectively solidifying the applied layer at points which correspond to a cross section of the object to be produced. In this case, the device is designed and/or controlled to repeat the steps of application and selective solidification until the object is finished, wherein firstly a support structure is formed on a construction platform and then the object is formed on the support structure and the support structure is formed so that it has a weakened region, which is arranged on average closer to the construction platform than to the object and which is more easily severable than the regions of the support structure adjacent in height. It is thus possible to execute the method according to the invention by means of the device for producing a three-dimensional object.

Further features and advantages of the invention result from the description of exemplary embodiments on the basis of the appended drawings.

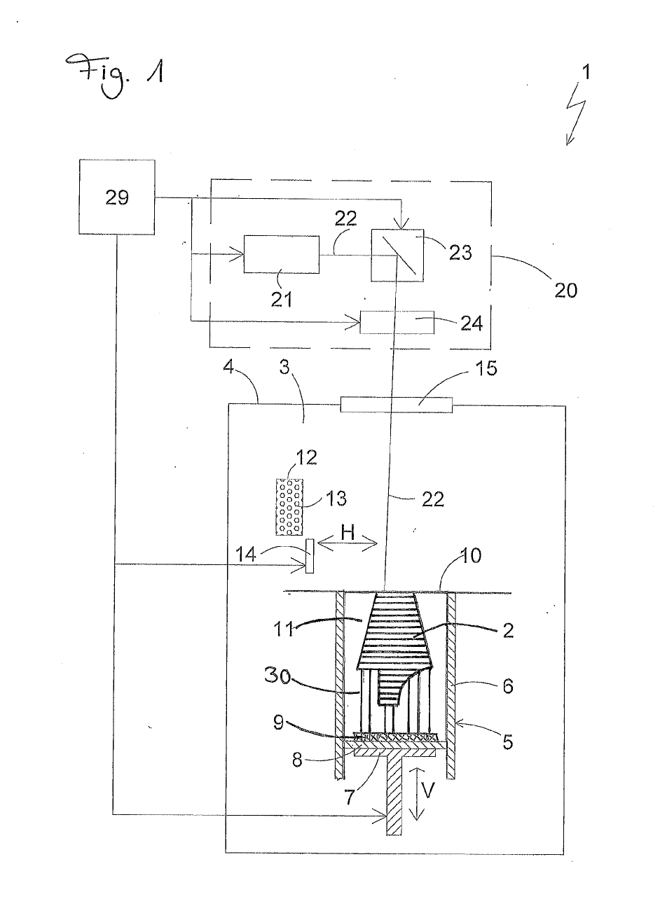

FIG. 1 is a schematic view in partial section of an exemplary embodiment of a device for layer-by-layer production of a three-dimensional object, which is suitable for carrying out a method according to the invention.

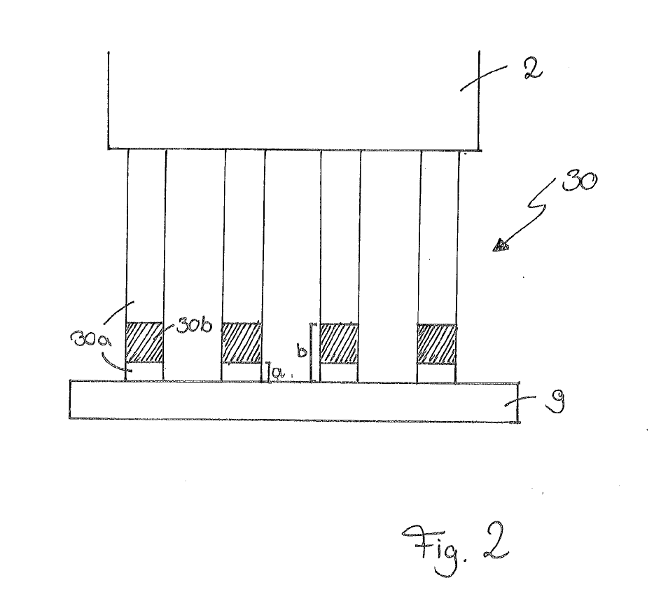

FIG. 2 is a schematic view in section of a support structure having a weakened region according to a first embodiment of the invention.

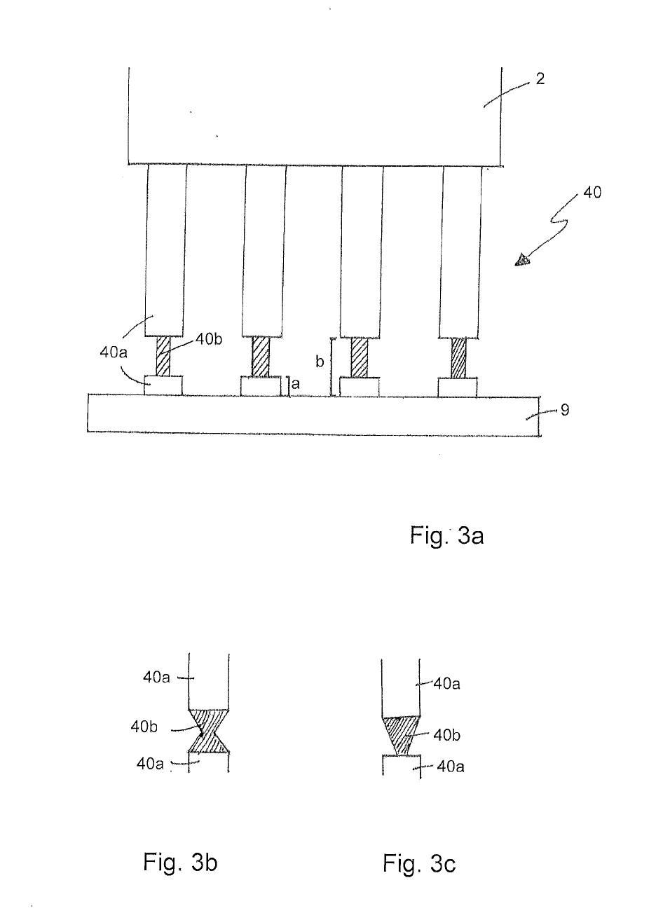

FIGS. 3a-3c are schematic views in section of support structures according to a second embodiment of the invention.

An exemplary embodiment of a device, which is suitable for carrying out a method according to the invention, is described hereafter with reference to FIG. 1. The device shown in FIG. 1 is a laser sintering or laser melting device 1. For building up an object 2, it contains a process chamber 3 having a chamber wall 4.

A container 5, which is open on top, having a wall 6 is arranged in the process chamber 3. A carrier 7, which is movable in a vertical direction V, and on which a base plate 8 is attached, which terminates the container 5 on the bottom and therefore forms its floor, is arranged in the container 5. The base plate 8 can be a plate formed separately from the carrier 7, which is fastened on the carrier 7, or it can be integrally formed with the carrier 7. Depending on the powder and process used, a construction platform 9 can also be attached to the base plate 8, on which the support structure 30 and the object 2 are built up. The construction platform 9 is preferably manufactured from a material which is well compatible with the build-up material, so that the build-up material adheres to the construction platform 9 during the solidification. However, the support structure 30 and object 2 can also be built up on the base plate 8 itself, which is then used as the construction platform. In FIG. 1, the object 2 to be formed is shown on a support structure below a work level 10 in an intermediate state having multiple solidified layers, enclosed by non-solidified remaining build-up material 11.

The laser sintering device 1 furthermore contains a storage container 12 for a powdered build-up material 13, which can be solidified by electromagnetic radiation, and a coater 14, which is movable in a horizontal direction H, for applying the build-up material 13 on the work level 10. On its upper side, the wall 4 of the process chamber 3 contains a coupling window 15 for the radiation 22 used for solidifying the powder 13.

The laser sintering device 1 furthermore contains an exposure device 20 having a laser 21, which generates a laser beam 22, which is deflected via a deflection device 23 and is focused by a focusing device 24 via the coupling window 15 onto the work level 10.

Furthermore, the laser sintering device 1 contains a control unit 29, via which the individual components of the device 1 are controlled in a coordinated manner to carry out the construction process. The control unit can contain a CPU, the operation of which is controlled by a computer program (software). The computer program can be stored separately from the device on a storage medium, from which it can be loaded into the device, in particular into the control unit.

In operation, to apply a powder layer, firstly the carrier 7 is lowered by a height which corresponds to the desired layer thickness. By moving the coater 14 above the work level 10, a layer of the powdered build-up material 13 is then applied. The application is performed at least over the entire cross section of the object 2 to be produced, preferably over the entire construction field, i.e., the region of the work level 10 which is located inside the upper opening of the container 5. Subsequently, the cross section of the object 2 to be produced is scanned by the laser beam 22, so that the powdered build-up material 13 is solidified at the points which correspond to the cross section of the object 2 to be produced. These steps are repeated until the object 2 is finished and can be removed from the construction space. For this purpose, firstly the construction platform 9 having the support structure 30 and the object 2 formed thereon is removed from the construction space. The object 2 is then separated from the construction platform 9 by severing the support structure 30.

FIG. 2 shows a schematic sectional view of a support structure 30 according to a first embodiment. The support structure 30 is built up on the construction platform 9 and supports the object 2 or parts of the object 2. The support structure 30 has a weakened region 30b, and also non-weakened regions 30a above and below the weakened region 30b. The support structure 30 is embodied in FIG. 2 as parallel supports 30, which have a distance from one another in a plane parallel to the construction platform 9. Transverse connections (not shown in greater detail in FIG. 2) can be arranged between the individual supports 30, which connect adjacent supports to one another.

The weakened region 30b of the support structure 30 is arranged, above the construction platform 9, closer to the construction platform 9 than to the object 2. The weakened region 30b has a lower boundary, which has a distance a from the construction platform 9. The distance a is preferably at least 0.1 mm and/or at most 1.0 mm, particularly preferably at least 0.3 mm and/or at most 0.5 mm. Furthermore, the weakened region 30b has an upper boundary, which has a distance b from the construction platform 9. The distance b is preferably at least 0.3 mm and/or at most 5.0 mm, particularly preferably at least 0.5 mm and/or at most 2.5 mm.

The weakened region 30b is preferably formed, as shown in FIG. 2, so that it is arranged at a constant height above the construction platform 9 over the entire construction platform 9. The distances a and b of the lower and upper boundaries of the weakened region 30b are therefore of equal size for all supports shown in FIG. 2.

The weakened region 30b is distinguished in that it is more easily severable than the non-weakened regions 30a of the support structure 30, which are adjacent in height. According to the first embodiment, the weakened region 30b is formed in that the build-up material 13 is solidified less strongly in the weakened region 30b than in the non-weakened regions 30a. In the laser sintering or laser melting device 1 shown in FIG. 1, the build-up material 13 is solidified by radiation 22, and the weakened region 30b is formed according to the first embodiment in that the build-up material 13 is irradiated more weakly in the weakened region 30b than in the non-weakened regions 30a. In general, according to a first embodiment of the invention, less energy per unit of area is supplied to the build-up material 13 in the weakened region 30b than in the non-weakened regions 30a when the solidification of the build-up material 13 is performed by introduction of energy.

The support structure 30 can thus be severed rapidly and in a simple manner from the construction platform 9 after finishing of the object 2, since the weakened region 30b of the support structure 30 is more easily severable, while the non-weakened regions 30a of the support structure 30 above and below the weakened region 30b ensure good bonding of the component to the construction platform, and sufficient stability of the support structure.

In an alteration of the first embodiment, the weakened region 30b is formed in that a different build-up material 13 is solidified in the weakened region 30b than in the non-weakened regions 30a. The build-up material 13 which is solidified in the weakened region 30b is more easily severable after its solidification than the build-up material 13 of the non-weakened regions 30a. The same effects are thus achieved as by the less strong solidification of the build-up material 13 in the weakened regions 30b according to the first embodiment. Both variants (less strong solidification and different build-up material) can also be combined with one another.

FIG. 3a shows a schematic sectional view of a support structure 40 according to a second embodiment.

In the support structure 40, the weakened region 40b is formed in that the build-up material 13 is solidified so that the cross-sectional area of the support structure 40 in the weakened region 40b is smaller than the cross-sectional area of the non-weakened regions 40a after the solidification of the build-up material 13. FIG. 3a shows an example in which the cross-sectional area of a support is constant over the entire height of the weakened region 40b, wherein the cross-sectional area at the weakened region 40b of the support is smaller than on the non-weakened regions 40a. The weakened region 40b shown in FIG. 3a is more easily severable over its entire height than the non-weakened regions 40a of the support structure 40.

According to the alterations shown in FIGS. 3b and 3c, the cross section of the weakened region 40b can also vary over the height of the weakened region 40b, so that the weakened region 40b is particularly easily severable in at least a defined height. In the example shown in FIG. 3b, the weakened region 40b is particularly easily severable in its middle, in FIG. 3c in its lowermost region, which adjoins the non-weakened region 40a of the support structure 40.

In the examples shown in FIGS. 3a to 3c, the same build-up material can be used in the weakened regions 40b of the support structure 40 as in the non-weakened regions 40a with equal introduction of energy per unit of area. The smaller cross-sectional area in the weakened regions 40b is achieved in that the build-up material is solidified on a smaller cross-sectional area in the layers corresponding to the weakened regions 40b.

Because the build-up material 13 is solidified in a smaller cross-sectional area in the weakened regions 40b of the support structure 40 than in the non-weakened regions 40a, the support structure 40 is more easily severable in the weakened regions 40b.

The object 2 can thus be severed rapidly and in a simple manner from the construction platform 9 after it is finished by severing the support structure 40 in the weakened regions 40b. The non-weakened regions 40a of the support structure 40 above and below the weakened region 40b additionally ensure good bonding of the component to the construction platform 9, and also sufficient stability of the support structure 40.

The features of the second embodiment (inter alia, the smaller cross-sectional area) can be combined with those of the first embodiment (inter alia, less strong solidification and/or different material).

In a third embodiment (not shown in the figures), a smaller cross-sectional area is implemented in the weakened regions in that the introduction of energy per unit of area in the weakened regions is selected such that a porous structure results, while the introduction of energy per unit of area in the non-weakened regions is selected such that a homogeneously solidified structure results.

The support structure is not restricted to the example of parallel supports shown in the figures. Rather, the support structure can assume any arbitrary shape suitable for supporting the object or parts of the object.

Although the present invention was described on the basis of a laser sintering and/or laser melting device, it is not restricted to laser sintering or laser melting. It can be applied to arbitrary methods for producing a three-dimensional object by layer-by-layer application and selective solidification of a powdered build-up material.

For example, the laser can comprise a gas laser or solid-state laser or any other type of laser. In general, any apparatus can be used, using which energy can be applied selectively to a layer of the build-up material. Instead of a laser, for example, another light source, an electron beam, or any other energy or beam source can be used, which is suitable for solidifying the build-up material. The invention can also be applied to selective mask sintering, in which an extended light source and a mask are used, or to absorption or inhibition sintering.

Instead of the introduction of energy, the selective solidification of the applied build-up material can also be performed by 3-D printing, for example, by application of an adhesive. In general, the invention relates to the production of an object by means of layer-by-layer application and selective solidification of a powdered build-up material, independently of the manner in which the build-up material is solidified.

Various materials can be used as the build-up material, in particular powdered materials, for example, metal powder, plastic powder, ceramic powder, sand, filled or mixed powders. A particularly good effect is achieved in particular in the case of metal powders, since metallic materials are particularly difficult to sever and the weakened region of the support structure makes the severing from the construction platform particularly easy.

1. Method for producing a three-dimensional object by layer-by-layer application and selective solidification of a build-up material having the steps:
applying a layer of the build-up material on a construction field by means of a coater moving over the construction field,
selectively solidifying the applied layer at points which correspond to a cross section of the object to be produced, and
repeating the steps of application and selective solidification until the object is finished,
wherein by the above steps, firstly a support structure is formed on a construction platform and then the object is formed on the support structure, has a weakened region, which is arranged on average closer to the construction platform than to the object and which is more easily severable than the regions of the support structure adjacent in height.

2. Method according to claim 1, wherein the weakened region of the support structure is formed in that the build-up material is solidified less strongly there than in the regions of the support structure adjacent in height.

3. Method according to claim 2, wherein the solidification of the material is performed by introducing energy and
the weakened region of the support structure is formed in that less energy per unit of area is supplied there to the build-up material than to the regions of the support structure adjacent in height.

4. Method according to claim 3, wherein the solidification of the material is performed by radiation and the weakened region of the support structure is irradiated more weakly to solidify the build-up material than in the regions of the support structure adjacent in height.

5. Method according to claim 1, wherein the weakened region of the support structure is formed in that the solidified cross-sectional area of the support structure is smaller there than that at the regions of the support structure adjacent in height.

6. Method according to claim 1, wherein the support structure is formed so that it consists of individual supports having a distance in parallel to the construction platform between them.

7. Method according to claim 6, wherein transverse connections are arranged in sections between the individual supports, which connect adjacent supports to one another.

8. Method according to claim 1, wherein the weakened region of the support structure is formed so that it is arranged at a substantially constant height above the construction platform over the entire construction platform.

9. Method according to claim 1, wherein a lower boundary of the weakened region of the support structure is spaced apart from the construction platform, preferably is located at least 0.1 mm and/or at most 1.0 mm, particularly preferably at least 0.3 mm and/or at most 0.5 mm above the construction platform.

10. Method according to claim 1, wherein an upper boundary of the weakened region of the support structure is located at least 0.3 mm and/or at most 5.0 mm, preferably at least 0.5 mm and/or at most 2.5 mm above the construction platform.

11. Method according to claim 1, wherein the build-up material is a powdered material.

12. Method according to claim 11, wherein the build-up material is a metal powder.

13. Computer program, which is loadable into a programmable control unit, having program code means to execute all steps of a method according claim 1 when the computer program is executed on the control unit.

14. Control unit for a device for producing a three-dimensional object by layer-by-layer application and selective solidification of a build-up material, wherein the device comprises:
a coater movable over a construction field for applying a layer of the build-up material to the construction field and
a solidification device for selectively solidifying the applied layer at points which correspond to a cross section of the object to be produced,
wherein the device is designed and/or controlled:
to repeat the steps of application and selective solidification until the object is finished,
wherein the control unit is designed to control the device so that it
firstly forms a support structure on a construction platform and then forms the object on the support structure and
forms the support structure so that it has a weakened region, which is arranged on average closer to the construction platform than to the object and which is more easily severable than the regions of the support structure adjacent in height.

15. Device for producing a three-dimensional object by layer-by-layer application and selective solidification of a build-up material, comprising:
a coater movable over a construction field for applying a layer of the build-up material to the construction field and
a solidification device for selectively solidifying the applied layer at points which correspond to a cross section of the object to be produced,
wherein the device is designed and/or controlled:
to repeat the steps of application and selective solidification until the object is finished,
to firstly form a support structure on a construction platform and then form the object on the support structure and
to form the support structure so that it has a weakened region which is arranged on average closer to the construction platform than to the object and which is more easily severable than the regions of the support structure adjacent in height.
